(19) United States
(12) Patent Application Publication
(10) Pub. No.: US 2005/0246291 A1
(43) Pub. Date: Nov. 3, 2005

(54) System and method for creating an account using biometric information

(76) Inventors: David Delgrosso, Naperville, IL (US); Fraser Orr, Naperville, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/105,759

(22) Filed: Apr. 14, 2005

Related U.S. Application Data
(60) Provisional application No. 60/562,147, filed on Apr. 14, 2004.

(51) Int. Cl. G06F 17/60

(52) U.S. Cl. 705/67; 705/44

(57) ABSTRACT

A system and method for creating a user account record based on biometric information is provided. A biometric credential such as a fingerprint scan is provided, and is matched against records stored in a database. Information recalled in that search is compared against non-biometric information provided by a prospective user, thereby providing for the verification of the identity of the prospective user. Based on the verification of the identity of the prospective user, a new user account record is created.

### CROSS-REFERENCE TO RELATED APPLICATIONS

This application claims priority of U.S. Provisional Application No. 60/562,147 filed on Apr. 14, 2004, which is expressly incorporated herein by reference. This application is also a continuation-in-part of a U.S. Patent Application, filed on Apr. 8, 2005 and bearing attorney docket number 4101 P 017, which is expressly incorporated herein by reference.

### TECHNICAL FIELD

The invention relates to a biometric credential system. More specifically, the invention is directed to a system and method for creating a user account, wherein the account is created based on biometric credential information provided by the user.

### BACKGROUND OF THE INVENTION

Several types of systems for creating new user accounts are known. In one such system, information regarding the user, such as the user's name, address, phone number and the like is received and input into a storage, such as a file cabinet or computer memory, for later recall.

Some user account creation systems require the identity of the user to be verified before the user account is created. For example, the creating authority, such as a bank, may require the user to present an identification card such as a driver's license to verify the user's identity. In some such systems, information provided by the user is checked against stored information regarding the user; for example, the user's driver's license number may be checked against a database to determine whether the user has a criminal history. In another variation, historical information regarding the user, such as a credit report, may be analyzed to determine whether to create a user account.

Those systems are reliant on the authenticity of the information provided by the user. For instance, a forged identification card can result in the creation of a user account based on a false identity. Likewise, a lost identification card can result in unauthorized access to a user account. Moreover, prior art systems often require the retrieval of information from disparate data sources that typically require different types of authentication information and therefore require significant time for the recall of data. Lastly, prior art systems also typically require a human attendant for the receipt and entry of user information; that human element introduces the likelihood of human error and further exacerbates the amount of time required for the creation of the user account.

Administrative access systems for use with a biometrically protected system are known in the prior art. One such system is described in U.S. patent application Ser. No. 11/051,259, which is expressly incorporated herein by reference. The administrative access system described therein is capable of interface with the system of the present invention, and vice versa.

The present invention is provided to solve the problems discussed above and other problems, and to provide advantages and aspects not provided by prior account creation systems of this type. A full discussion of the features and advantages of the present invention is deferred to the following detailed description, which proceeds with reference to the accompanying drawings.

### SUMMARY OF THE INVENTION

A system and method for creating a user account based on biometric information is provided. A biometric credential is received from a user, and the biometric credential is verified against a database of biometric information, thereby providing for the verification of the user's identity. Non-biometric information is received from the user, and is verified against information stored in a database. A new account record for the user is created based on at least the non-biometric information.

In one embodiment, the account record is based on both the non-biometric information and the biometric credential, allowing for later retrieval of the user account based on either the non-biometric information or the biometric credential. In another embodiment, if the received non-biometric information is not accurate, an alert is generated indicating the inaccuracy of the non-biometric information. In another embodiment, the non-biometric information is updated and thereby brought to accuracy.

Historical information regarding the user is analyzed, and an advisory determination is generated based on the analysis of the historical information. In a preferred embodiment, the biometric credential and non-biometric information are stored in separate databases; in another embodiment, those data are stored in the same database.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a schematic flowchart illustrating the steps and elements of a process embodying the principles of the present invention.

FIG. 2 is a screen capture image of a computer software program configured in accordance with the principles of the present invention, illustrating a selection window, whereby a user of the software program indicates whether a prospective user is a new or existing customer of a verifying institution.

FIG. 3 is a screen capture image of a computer software program configured in accordance with the principles of the present invention, illustrating a new customer information window, whereby a user of the software program enters non-biometric information into the software, to be stored in the non-biometric database.

FIG. 4 is a screen capture image of a computer software program configured in accordance with the principles of the present invention, illustrating a non-biometric information identification window, whereby a user of the software program selects the type of non-biometric information is used by the prospective user to identify herself.

FIG. 5 is a screen capture image of a computer software program configured in accordance with the principles of the present invention, illustrating a biometric credential input utility window, whereby a prospective user enters biometric credential data into the account creation system to verify her identity.

FIG. 6 is a screen capture image of a computer software program configured in accordance with the principles of the present invention, illustrating a account information selection window, whereby a user of the software program selects whether she desires to enter new account information data.

FIG. 7 is a screen capture image of a computer software program configured in accordance with the principles of the present invention, illustrating a new account data window, whereby a user of the software program enters new account information to the system.

FIG. 8 is a screen capture image of a computer software program configured in accordance with the principles of the present invention, illustrating a customer notes window, whereby a user of the software program enters commentary regarding a user to a database configured to store information regarding the user.

FIG. 9 is a screen capture image of a computer software program configured in accordance with the principles of the present invention, illustrating a co-owner selection window, whereby a user of the software program indicates whether she desires to add information to the system regarding a co-owner of a newly created account.

FIG. 10 is a screen capture image of a computer software program configured in accordance with the principles of the present invention, illustrating a co-owner entry window, whereby a user of the software program enters non-biometric information regarding a co-owner of a newly created account.

FIG. 11 is a screen capture image of a computer software program configured in accordance with the principles of the present invention, illustrating a biometric credential and non-biometric information input window, whereby a user of the software program supplies both a biometric credential and non-biometric information to the system for later identification of the user.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspects of the invention to the embodiments illustrated.

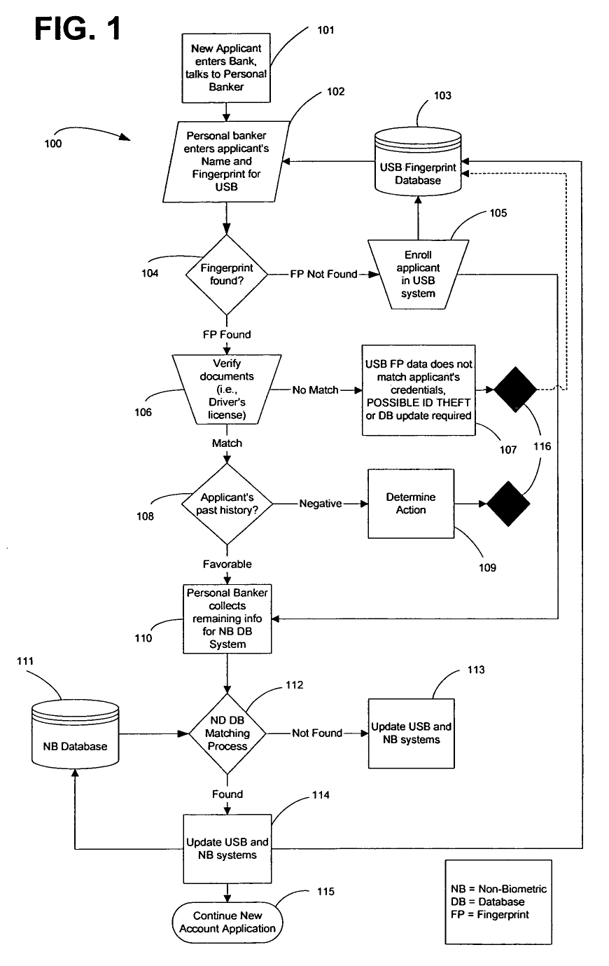

Referring to FIG. 1, a schematic flowchart is provided illustrating the steps and elements of a system 100 for the creation of a user account based on biometric information. The present invention will be described in the setting of a bank, and the creation of a new user account will, for illustrative purposes, be described as the creation of a new bank account for a user. However, it will be understood that the principles of the present invention are not limited to a bank environment, and can be used for the creation of any type of new user account, such as a new driver's license, tax identity, insurance account, investment account, website access account, facility access account and the like. The principles of the present invention allow for the creation of a new user account in any setting in which the creation of a new user account based on biometric information is desirable.

Initially and as illustrated at step 101, a new user desires the creation of a new user account. The user provides a biometric credential in step 102. The biometric credential can be a fingerprint scan, retinal scan, biorhythm datum, DNA sample, blood sample, hair follicle, user image or any other data obtained biometrically from the user and highly corresponding to a unique identity of the user. The provision of the biometric credential, step 102, can be performed under the attendance of a supervision authority such as a personal banker or other attendant, or can be performed without an attending authority.

The biometric credential information is transmitted to a biometric database 103, which stores records of biometric credential information. A search query is generated comprising at least the biometric credential, such as the image created by the fingerprint scan. Additional information can be added to the search query, such as the new user's name, telephone number, social security number or other identifying information. The biometric database 103 is searched with the search query to determine whether the user's biometric information exists in the database 103. If no match for the user is found in the database 103, the new user's information is stored, in step 105, as a new biometric record in the database 103.

The biometric database 103 can be located centrally, such as in a bank database local to the bank premises. The database 103 can also be located remotely, such as a remote database capable of communication with multiple bank branches and multiple facilities. The database 103 can be populated with biometric information available from a variety of sources, such as the Federal Bureau of Investigation fingerprint database, local and state police fingerprint databases, employer biometric databases, and the like. The system thus allows for the matching of biometric information from the new user against biometric information provided to a different authority, such as the Federal Bureau of Investigation; thereby, the user's biometric information can be used to verify the identity of the user even if the party seeking verification, such as a bank, is entirely unfamiliar with the user.

Next and as illustrated in step 106, non-biometric information is received. In a preferred embodiment, the non-biometric information is received from the user. For example, the user may be asked to provide a driver's license, social security card or social security number, birth certificate, tax return, residential or commercial lease, user name, password or other non-biometric information identifying herself. The user's purported identity, provided through the provision of the non-biometric information in step 106, is analyzed in step 107 to determine its authenticity.

The comparison between the biometric information recalled in step 104, and the non-biometric information presented in step 106, is to verify the accuracy of the information presented in step 106. For example, the user may provide a fingerprint scan indicating that her identity is Jane Doe. The search in step 104 of the biometric database 103, will preferably result in the retrieval of non-biometric information (such as the name Jane Doe, the driver's license number or social security number of Jane Doe, and the like) further indicating the user's identity as being that of Jane Doe. If, however, the user provides information, such as a driver's license, purporting her identity to be that of Britney Spears, the bank or other institution seeking verification of the user's identity will thereby be made aware of the discrepancy between the stored user information and the purported user information. In short, the system allows for the comparison of stored non-biometric information with non-biometric information provided by the new user.

In a preferred embodiment and as illustrated by step 107, an alert is generated based on a determination that the user-provided non-biometric information does not match the non-biometric information stored in database 103 regarding the user. The alert may indicate a forgery or fraudulent presentation of the user-provided non-biometric information, such as a forged or stolen identification card or social security number. In that event, the authorizing institution, e.g. bank, can take appropriate action, such as a communication to a law enforcement agency. Alternatively, the authorizing institution can request additional non-biometric information from the new user, such as a birth certificate or passport, to further try to reconcile the discrepancies between the non-biometric data. The alert may also indicate that the non-biometric information recalled from the database 103 is simply untimely, such as would be the case in the event of a name or address change of the new user. In that event, and as illustrated by the communication from step 107 to database 103, the user's stored non-biometric information can simply be updated and thereby brought to accuracy. Alternatively, and as illustrated by step 116, the new user account creation process can be terminated owing to the inability to verify the user's identity.

In a preferred embodiment and as illustrated by step 108, an analysis is made of historical information regarding the user. For example, the user's information, either biometric or non-biometric, is used to recall the user's credit report, criminal record, business rating, credit balance or the like. As will be understood, authorizing institutions such as banks rely on a wide variety of information sources to analyze a prospective user's historical information before creating a new account for that user; that is the analysis illustrated by step 108. By and through the present invention, however, that historical information can be recalled conveniently based on the presentation of the user's biometric credential in step 102. Likewise, by biometrically verifying the user's identity, in steps 102, 104, 106 and 107, the present invention avoids the analysis of historical information regarding a person who is not, in fact, the prospective user.

As illustrated in steps 109 and 110, an advisory determination is generated based on the analysis of the historical information in step 108. For example, if the prospective user has a favorable credit history, the analysis of the prospective user's history will result in a favorable determination, in step 110, tending toward the creation of a new user account. If, however, the historical analysis reflects negatively on the user (such as a poor credit rating or criminal history), the analysis will result in a negative determination, in step 109, tending against the creation of a new user account. As illustrated in step 109, the advisory determination is merely advisory; the negative determination can be ignored and a new user account created despite that determination, or alternatively and as illustrated by step 116, the new account creation process can be terminated.

Having biometrically confirmed the identity of the prospective user, a new user account record can be created. As illustrated by step 112, a search of a non-biometric database 111 is performed for information matching the non-biometric information of the prospective user. As will be understood, that search 112 is performed to avoid the creation of a duplicate account for the user, as would be the case if the user has already established a user account at the authorizing institution. Search 112 is also performed in the event that the user's appearance at the institution is not for the creation of a new account, but instead for the update of information regarding an existing account. If in step 112 a match is found between the user-provided non-biometric information and the stored non-biometric information in database 111, the user's non-biometric information is updated, if necessary, in step 114. If a match is not found in database 111, a new non-biometric record for the user is generated and stored in database 111, as illustrated by step 113.

Preferably, the update and/or new record generation performed in steps 113 and 114 affects the entry of data not only in database 111, but also in database 103. By and through that aspect of the present invention, the user's non-biometric information is notably stored for later retrieval by the instant authorizing institution, but is also stored and updated globally, for later retrieval by other authorizing institutions, such as other banks. Thus, the present invention provides for the a new account creation system that updates and verifies a user's non-biometric information for later retrieval by other institutions. Having stored, updated if necessary, and verified the user's non-biometric information, the new user's account record is generated, as illustrated by step 115.

The process described herein can be performed at an authorizing institution; for example, at a bank. However, the process can also be performed remotely, such as through the provision of biometric and non-biometric information from a home computer equipped with a biometric credential input device. The method described herein can also be performed under the supervision of a human attendant, such as a personal banking assistant, or without human supervision. The steps of verifying the user's non-biometric information, comparing the user's biometric credential data wit the user's non-biometric information, and analyzing the user's historical information are preferably performed by an analyst. The analyst is, in a preferred embodiment, a human attendant, such as a personal banking assistant. Alternatively, the analyst is artificial, e.g., a computer software program comprising logic to perform the analysis of the information.

In a preferred embodiment, biometric database 103 and non-biometric database 111 are separate and distinct databases. That separation provides for increased reliability and security of the present system, so that in the event that either database is compromised, the reliability of the information stored in the other database will not be compromised. However, it will be understood that database 103 and database 111 may, in keeping with the principles of the present invention, be the same database. It will also be understood that while databases 103 and 111 are preferably databases stored in a non-volatile computer memory, and specifically in a relational database structure, databases 103 and 111 may also be alternative storage components such as a filing cabinet or card catalog. It will also be understood that preferably, the non-biometric database 111 is specific to the authorizing institution, such as a bank, while biometric database 103 is preferably global and remote from the authorizing institution and thereby available for use by other authorizing institutions, such as other banks or government entities. However, it is equally within the scope of the present invention for both databases 103 and 111 to be owned, operated or otherwise contained within a single authorizing institution.

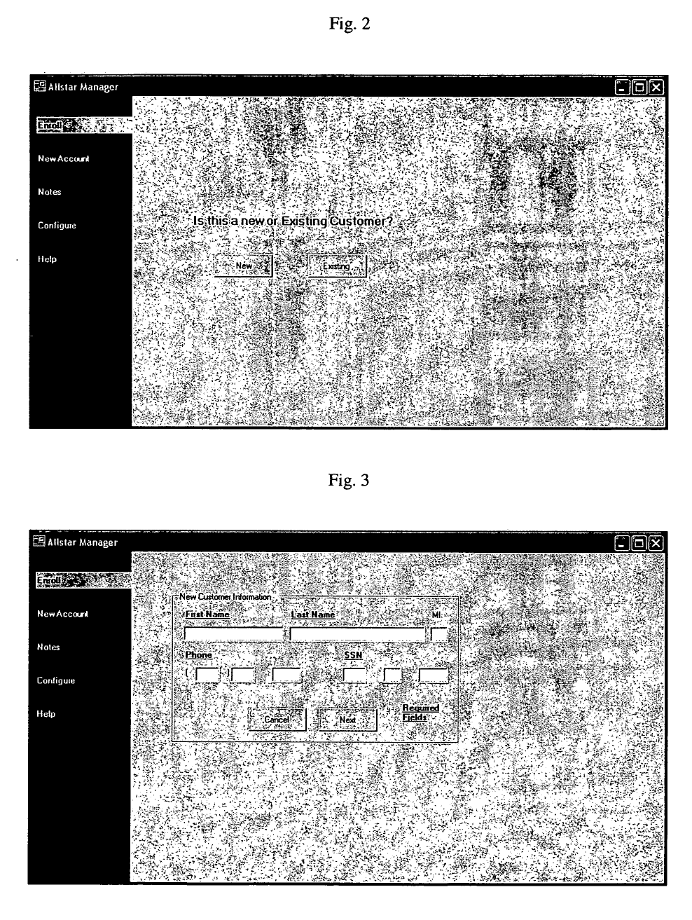

Referring to FIG. 2, there is illustrated a screen capture image of a selection window, to be used in a computer software program embodying the present invention. In the selection window, an attendant such as a personal banking assistant selects whether the prospective user is a new or returning user. If the prospective user is a new user, the new account creation system described herein enables the verifying institution, i.e. the bank, to verify the new user's identity and create an new account for that user.

Referring to FIG. 3, there is illustrated a screen capture image of a new customer information window, through which either an attendant or the prospective new user herself can enter non-biometric identifying information, such as a social security number, drivers license number and the like.

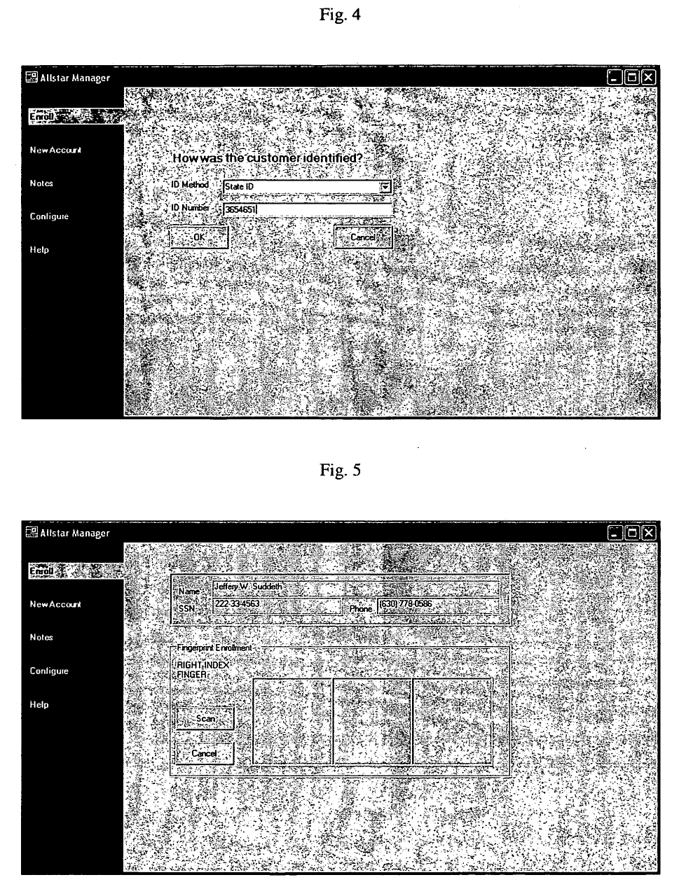

Referring to FIG. 4, there is illustrated a screen capture image of a non-biometric information identification window, for a computer program configured in accordance with the present invention. In that window, the prospective new user, or an attendant, selects which type of non-biometric information was provided in the new customer information window illustrated in FIG. 3. That selection is made to enable the system to efficiently search for the prospective user's records in databases 103 and 111.

Referring to FIG. 5, there is illustrated a biometric credential input utility window for a computer software program configured in accordance with the principles of the present invention. By that window, the prospective user provides a biometric credential, such as a fingerprint scan. The fingerprint image is scanned into the system, and a match for that credential—a matching fingerprint image—is sought in biometric database 103. The results of that search of database 103 enable the user's non-biometric information, such as name, social security number, etc., to be verified biometrically.

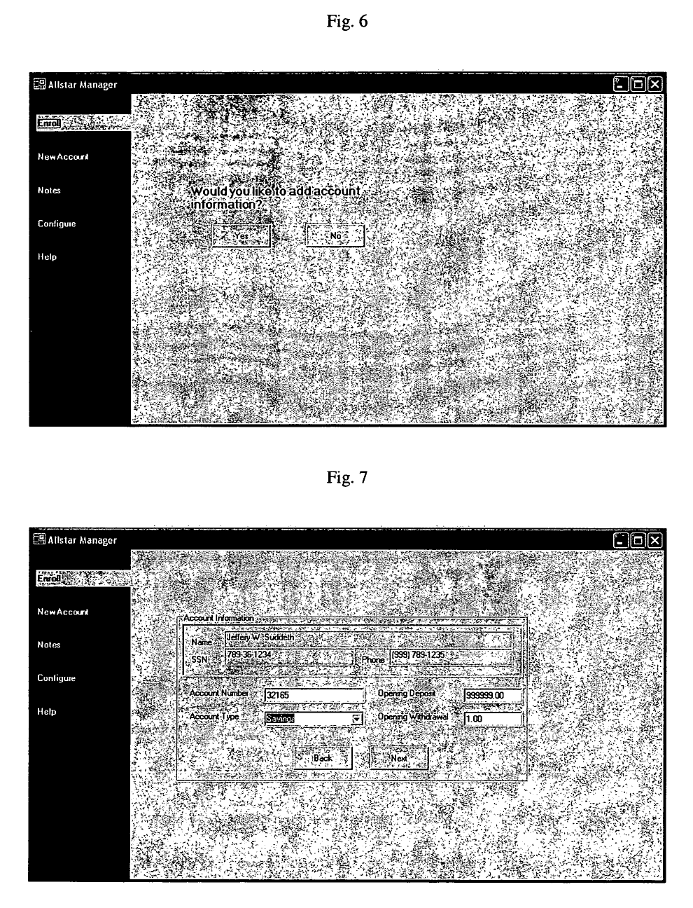

Referring to FIG. 6, there is illustrated an account information selection window for a computer software program embodying the present invention. By and through that window, which is displayed subsequent to the biometric verification of the new user's identity, an attendant can select whether to create new account information for the new user, now that the new user's identity has been verified.

Referring to FIG. 7, there is illustrated a screen capture image of a new account data window, for a computer software program embodying the present invention. In that window, which is displayed subsequent to the biometric verification of the new user's identity, an attendant can enter new account information for the user. For example, the attendant can enter the type of new account, such as “checking” or “saving”, and other relevant new account information, such as an opening balance.

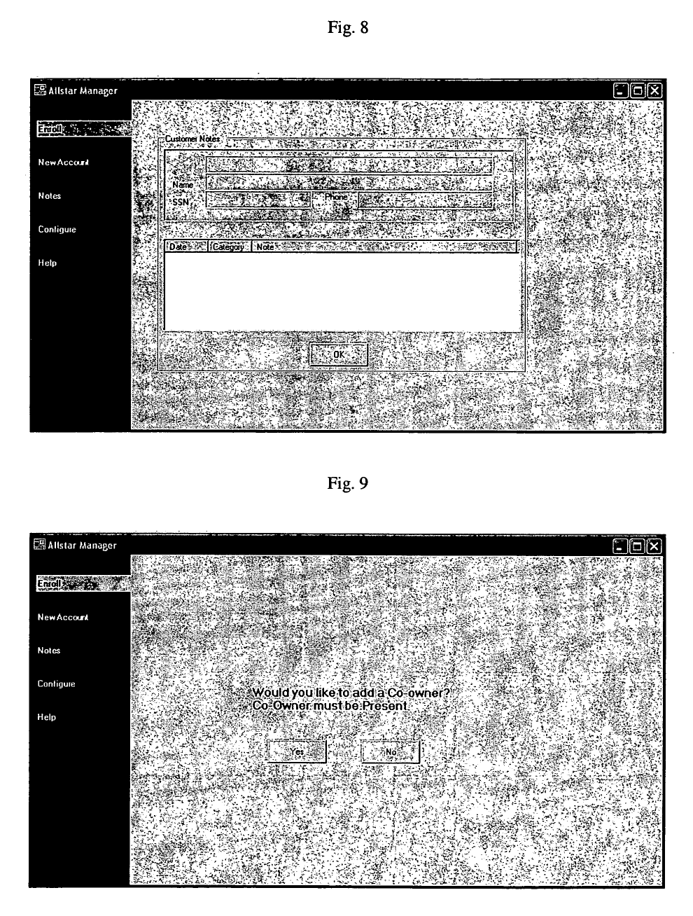

Referring to FIG. 8, there is illustrated a screen capture image of a customer notes window, for a computer program embodying the present invention. In that window, which is displayed for existing users, an attendant can enter a commentary note regarding a user. For example, if a user requires special assistance, such as a Braille keyboard, an attendant can enter a note to that effect into the system via the customer notes window.

Referring to FIG. 9, there is illustrated a screen capture image of a co-owner selection window, for a computer program embodying the present invention. In that window, which is displayed subsequent to the biometric verification of the new user's identity, an attendant can select whether the newly created user record is to have a co-owner. The co-owner selection window enables the attendant to progress to either entering information regarding the co-owner into the system, or to bypass that step.

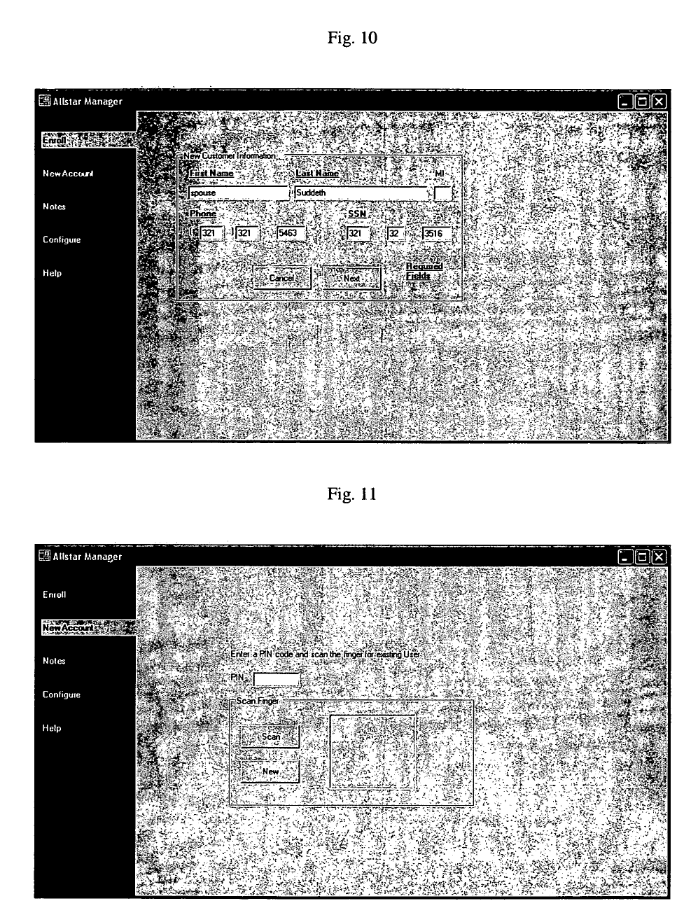

Referring to FIG. 10, there is illustrated a screen capture image of a co-owner entry window, for a computer program embodying the present invention. In that window, which is displayed pursuant to a request by an attendant in the co-owner selection window illustrated in FIG. 9, an attendant can enter information into the system regarding a co-owner for the newly created user account record.

Referring to FIG. 11, there is illustrated a biometric credential and non-biometric information input window, for a computer program embodying the present invention. In that window, a new user, whose identity has been biometrically established, can enter a biometric credential, such as a fingerprint image, into the system. That biometric credential can be stored in either database 103 or database 111, for later identification. By locally storing the user's biometric credential in database 111, the system enables the user's identity to be biometrically verified without consulting database 103, which may be remotely located and may require an access charge. Additionally and as illustrated in FIG. 11, the user may provide non-biometric information, such as a personal identification number (PIN). The combination of biometric credential and non-biometric identifying information stored locally in database 111 enables the system to verify the user's identity both biometrically and non-biometrically after the new user account is created.

Generally referring to FIGS. 2-11, non-biometric information regarding the user is provided, then a biometric credential is provided and a match for that biometric credential is sought from biometric database 103. Information returned from biometric database 103 is used to verify the new user's identity, and to verify the user's non-biometric information. New account information is provided, and a co-owner, if any, is added to the new user account, as are notes regarding the new user. Lastly, the user provides a biometric and/or non-biometric security information to be subsequently identified without reference to biometric database 103.

While the specific embodiments have been illustrated and described, numerous modifications come to mind without significantly departing from the spirit of the invention, and the scope of protection is only limited by the scope of the accompanying claims.

1. A system for creating a user account, comprising:
a first storage for storing a biometric credential, wherein the first storage is accessible from a plurality of remote locations;
a second storage for storing verified non-biometric information regarding a user; and,
a third storage for storing a new account record for the user, wherein the second and third storages are located remotely from the first storage.

2. The system of claim 1, further comprising:
a biometric credential input device for receiving the biometric credential.

3. The system of claim 1, further comprising:
a search query for determining whether the biometric credential exists in the first storage, wherein the search query comprises at least the biometric credential.

4. The system of claim 1, further comprising:
an analyst for verifying the identity of the user based on both the biometric credential and the non-biometric information.

5. The system of claim 1, further comprising:
an analyst for verifying the non-biometric information.

6. The system of claim 1, further comprising:
an analyst for analyzing historical information regarding the user and for creating an advisory determination based on the analysis of the historical information.

7. The system of claim 1, wherein the biometric credential is at least one of a fingerprint image or retinal scan image.

8. The system of claim 1, wherein the biometric credential is stored in a first memory, the non-biometric information is stored in a second memory and the account record is stored in a third memory.

9. The system of claim 8, wherein the first, second and third memories are separate and distinct from each other.

10. A method for creating a user account, comprising the steps of:
providing for receiving a biometric credential;
providing for searching a memory for the biometric credential, wherein the memory is accessible from a plurality of remote locations;
providing for verifying the identify of a user based on the biometric credential;
providing for receiving non-biometric information regarding the user; and,
providing for creating an account record for the user.

11. The method of claim 10, further comprising the steps of:
providing for determining whether the biometric credential is stored in the memory; and,
providing for storing the biometric credential in the memory upon a determination that the biometric credential is not stored in the memory.

12. The method of claim 10, further comprising the steps of:
providing for verifying the identity of the user based on both the biometric credential and the non-biometric information.

13. The method of claim 10, further comprising the steps of:
providing for verifying the non-biometric information.

14. The method of claim 10, further comprising the steps of:
providing for updating the non-biometric information.

15. The method of claim 10, further comprising the steps of:
providing for analyzing historical information regarding the user; and,
providing for creating an advisory determination based on the analysis of the historical information.

16. The method of claim 10, wherein the biometric credential is at least one of a fingerprint image or retinal scan image.

17. The method of claim 10, wherein the biometric credential is stored in a first memory, the non-biometric information is stored in a second memory and the account record is stored in a third memory.

18. The method of claim 10, wherein the first, second and third memories are separate and distinct from each other.

19. The method of claim 10, further comprising the steps of:
providing for generating an alert upon a determination that the non-biometric information is inaccurate.

20. A method for creating a user banking account at a banking location based on an image of a fingerprint scan, comprising the steps of:
searching a memory for a matching image of the fingerprint scan, wherein the memory is located remotely from the banking location;
recalling non-biometric information regarding the user from the memory;
verifying the non-biometric information;
generating an alert upon a determination that the non-biometric information is inaccurate;
analyzing historical information regarding the user;
generating an advisory determination based on the analysis of the historical information; and,
creating a user banking account record for the user.
